(19) United States
(12) Patent Application Publication
(10) Pub. No.: US 2008/0278487 A1
(43) Pub. Date: Nov. 13, 2008

(54) Method and Device for Three-Dimensional Rendering

(75) Inventor: Jean Gobert, Alfortville (FR)

Correspondence Address: NXP, B.V.;NXP INTELLECTUAL PROPERTY DEPARTMENT, M/S41-SJ, 1109 MCKAY DRIVE, SAN JOSE, CA, 95131, US

(73) Assignee: NXP B.V., Eindhoven (NL)

(21) Appl. No.: 11/910,843

(22) PCT Filed: Apr. 3, 2006
(86) PCT No.: PCT/IB06/50998

§ 371 Date: Oct. 5, 2007

(30) Foreign Application Priority Data
Apr. 7, 2005 (EP) 05300258.0

(51) Int. Cl. G06T 17/00; G06K 9/00

(52) U.S. Cl. 345/420; 382/103

(57) ABSTRACT

The present invention provides an improved method and system to generate a real time three-dimensional rendering of two-dimensional still images, sequences or two-dimensional videos, by tracking (304) the position of a targeted object in the images or videos and generate the three-dimensional effect using a three-dimensional modeller (308) on each pixel of the image source.

### FIELD OF THE INVENTION

The present invention generally relates to the field of generation of three-dimensional images, and, more particularly, to a method and device for rendering a two-dimensional source in three-dimension, the two-dimensional source including in a video or a sequence of images, at least one moving object, said moving object comprising any type of object in motion.

### BACKGROUND OF THE INVENTION

Estimating the shape of an object in the real three-dimensional world utilizing one or more two-dimensional images, is a fundamental question in the area of computer vision. The depth perception of a scene or an object is known to humans mostly because the vision obtained by each of our eyes simultaneously could be combined and formed the perception of a distance. However, in some specific situations, humans could have a depth perception of a scene or an object with one eye when there is additional information, such as lighting, shading, interposition, pattern or relative size. This is why it is possible to estimate the depth of a scene or an object with a monocular camera, for example.

Reconstruction of three-dimensional images or models from two-dimensional still images or video sequences has important ramifications in various areas, with applications to recognition, surveillance, site modelling, entertainment, multimedia, medical imaging, video communications, and a myriad of other useful technical applications. Specifically, depth extraction from flat two-dimensional contents is an ongoing field of research and several techniques are known. For instance, there are known techniques specifically designed for generating depth maps of a human face and body, based on the movements of the head and body.

A common method of approaching this problem is analysis of several images taken at the same time from different view points, for example, analysis of disparity of a stereo pair or from a single point at different times, analysis of consecutive frames of a video sequence, extraction of motion, analysis of occluded areas, etc. Others techniques yet use other depth cues like defocus measure. Some other techniques combine several depth cues to obtain reliable depth estimation. For example, EP 1 379 063 A1 to Konya describes a mobile phone that includes a single camera for picking up two-dimensional still images of a person's head, neck and shoulders, a three-dimensional image creation section for providing the two-dimensional still image with parallax information to create a three-dimensional image, and a display unit for displaying the three-dimensional image.

However, the above example including the conventional techniques described above are not often satisfactory due to a number of factors. Systems based on a stereo pair of images imply the cost of additional camera so that the image is to be captured on the same set where it is displayed. Moreover, this approach cannot be used when the capture is done elsewhere and if only a single view is available. Also, systems based on motion and occlusion analysis fall short when there is insufficient motion or no motion at all. Equally, systems based on defocus analysis fail when there is no noticeable focussing disparity, which is the case when pictures are captured with very short focal length optics, or poor quality optics, which is likely to occur in low-cost consumer devices, and system combining several clues are very complex to implement and hardly compatible with a low-cost platform. As a result, lack of quality, robustness, and increased costs contribute to the problems faced in these existing techniques.

Therefore, it is desirable to generate depth for three-dimensional imaging from two-dimensional objects such as video and animated sequences of images using an improved depth generation method and system which avoids the above mentioned problems and can be less costly and simpler to implement.

### SUMMARY OF THE INVENTION

Accordingly, it is an object of the invention to provide an improved method and device to generate a real time three-dimensional rendering of two-dimensional still images, sequences or two-dimensional videos, by tracking the position of a targeted object in the images or videos and generate the three-dimensional effect using a three-dimensional modeller on each pixels of the image source.

To this end, the invention relates to a method such as described in the introductory part of the description and which is moreover characterized in that it comprises:
detecting a moving object in a first image of the video or sequence of images;
rendering the detected moving object in three-dimension;
tracking the moving object in subsequent images of the video or sequence of images; and
rendering the tracked moving object in three-dimension.

One or more of the following features may also be included.

In one aspect of the invention, the moving object includes a head and a body of a person. Further, the moving object includes a foreground defined by the head and the body and a background defined by remaining non-head and non-body areas.

In another aspect, the method includes segmenting the foreground. Segmenting the foreground includes applying a standard template on the position of the head after detecting its position. It is moreover possible to adjust the standard template by adjusting the standard template according to measurable dimensions of the head during the detecting and tracking steps, prior to performing the segmenting step.

In yet another aspect of the invention, segmenting the foreground includes estimating the position of the body relative to an area below the head having similar motion characteristics as the head and delimited by a contrasted separator relative to the background as the body.

Moreover, the method further tracks a plurality of moving objects, where each of the plurality of moving objects has a depth characteristic relative to its size.

In another aspect, the depth characteristic for each of the plurality of moving objects renders larger moving objects appear closer in three-dimension than smaller moving objects.

The invention also relates to a device configured to render a two-dimensional source in three-dimension, the two-dimensional source including in a video or a sequence of images, at least one moving object, said moving object comprising any type of object in motion, wherein the device comprises:
a detecting module adapted to detect a moving object in a first image of the video or sequence of images;
a tracking module adapted to track the moving object in subsequent images of the video or sequence of images; and
a depth modeller adapted to render the detected moving object and the tracked moving object in three-dimension.

Other features of the method and device are further recited in the dependent claims.

### BRIEF DESCRIPTION OF THE DRAWINGS

The present invention will now be described, by way of example, with reference to the accompanying drawings in which:

FIG. 1 shows a conventional three-dimensional rendering process;

FIG. 2 is a flowchart of an improved method according to the present invention;

FIG. 3 is a schematic diagram of a system using the method of FIG. 2;

FIG. 4 is a schematic illustration of one of the implementations of the invention; and

FIG. 5 is a schematic illustration of another implementation.

### DESCRIPTION OF THE PREFERRED EMBODIMENTS

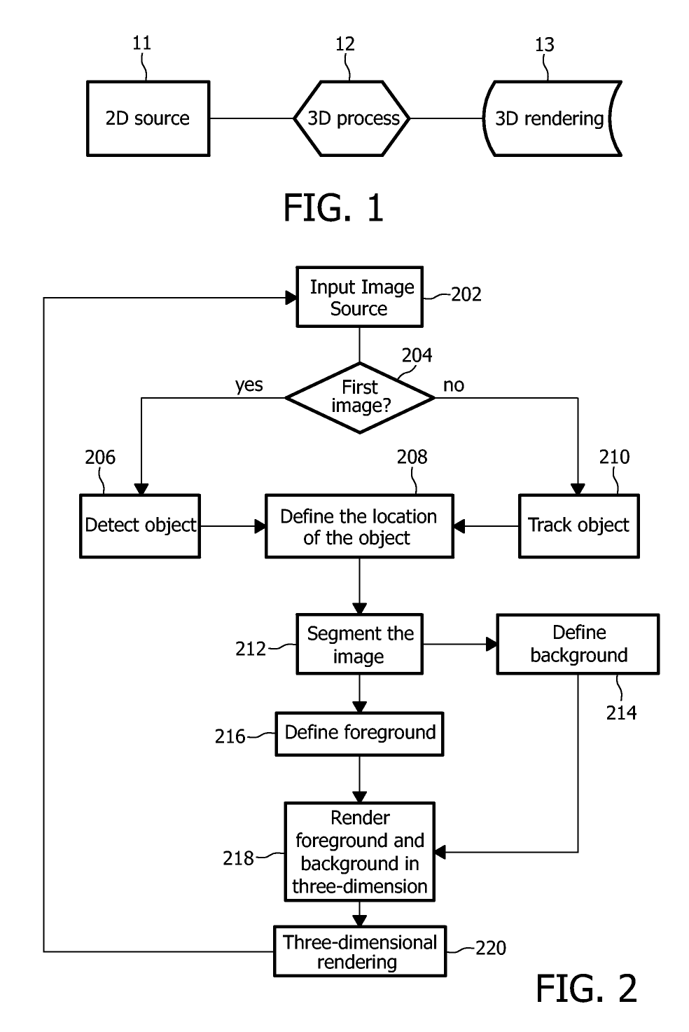

Referring to FIG. 1, which generally relates to techniques for generating three-dimensional images, an information source 11 in two-dimension undergoes a typical method 12 of depth generation for two-dimensional objects in order to obtain a three-dimensional rendering 13 of the flat 2D source. Method 12 may incorporate several techniques of three-dimensional reconstruction such as processing multiple two-dimensional views of an object, model-based coding, using generic models of an object (e.g., of a human face) and the like.

FIG. 2 illustrates a three-dimensional rendering method according to the present invention. Upon input of a two-dimensional source (202) such as an image, a still or animated set of video images, or sequence of images, the method selects whether the image is composed of the very first image (204). If the input information is the first image, then the image of the object in question is detected (206) and a location of the object is defined (208). If the method does not register that the input information is the first image in the step 204, then the image of the object in question is tracked (210) and the location of the object goes on to be defined (208).

Then, the image of the object in question is segmented (212). Upon segmentation of the image, the background (214) and the foreground (216) are defined, and both are rendered in three-dimension (218).

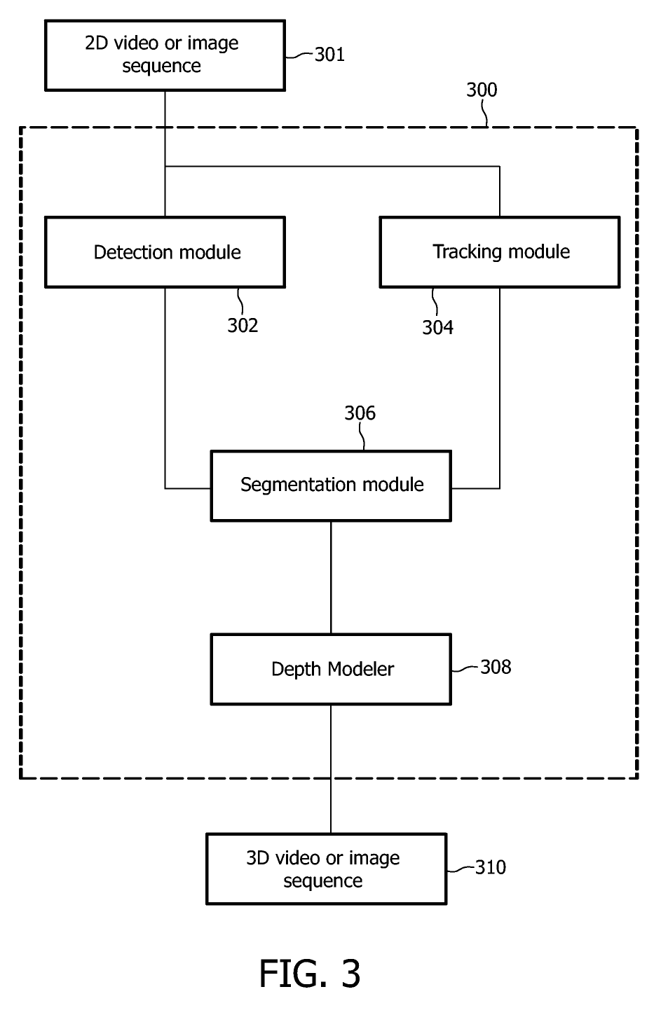

FIG. 3 illustrates a device 300 carrying out the method of FIG. 2. This device includes a detection module 302, a tracking module 304, a segmentation module 306 and a depth modeller 308. The device system 300 processes a two-dimensional video or image sequence 301 which results in the rendering of a three-dimensional video or image sequence 309.

Referring now both to FIGS. 2 and 3, the three-dimensional rendering method and the device system 300 will be described in further detail. On processing the first image of a video or image sequence 301, the detection module 302 detects the location or position of a moving object. Once detected, the segmentation module 306 extrapolates the area of the image to render in three-dimension. For example, for purposes of rendering the face and body of a person in three-dimension, a standard template may be used for estimating what makes up essentially the background and the foreground of the targeted image. This technique would estimate the location of the foreground (e.g., head and body) by placing the standard template on the position of the head. Different techniques besides the use of standard templates may be used to estimate the position of the targeted object for three-dimensional rendering. An additional technique which may also be used to improve the precision of the implementation of the standard template would be to adjust or scale the standard template according to the size of the extracted object (e.g., the size of the head/face).

Another approach may use motion detection to analyze the area immediately surrounding the moving object to detect an area having a consistent pattern of motion as the moving object. In other words, in the case of a person's head/face, the areas below the detected head, i.e., the body including the shoulder and torso areas, would move in a similar pattern as the person's head/face. Therefore, areas which are in motion and are moving similarly to the moving object are candidates to be part of the foreground.

Furthermore, a boundary check for contrast of the image may be performed on the specific candidate areas. When processing the images, the candidate areas with maximal contrast edge are set as foreground area. For example, in a generic outdoor image, the largest contrast may naturally be between the outdoor background and a person (foreground). Thus, for the segmentation module 306, this method of foreground and background segmentation of building the area below the object that has approximately the same motion as the object and adjusting the boundaries of the object to a maximum contrast edge to approximately fit to the object, would be particularly advantageous for video images.

Various picture processing algorithms may be utilized to segment the image of the object or the head and shoulders into two objects, the character and the background. As a result, the tracking module 304 would implement a technique of object or face/head tracking, as further discussed below. First, the detection module 302 would segment the image into the foreground and the background. Once the image has been adequately segmented as foreground and background in the step 212 of FIG. 2, the foreground is processed by the depth modeller 308 which renders the foreground in three-dimension.

For example, a possible implementation of depth modeller 308 begins with the building of depth models for the background and for the object in question, in this case, the head and body of a person. The background may have a constant depth, while the character can be modelled as a cylindrical object generated by its silhouette rotating on a vertical axis, placed ahead or in front of the background. This depth model is built once and stored for use by the depth modeller 308. Therefore, for purposes of depth generation for three-dimensional imaging, i.e., producing a picture that can be viewed with a depth impression (three-dimensional) from ordinary flat two-dimensional images or pictures, a depth value for each pixel of the image is generated, thus resulting in a depth map. The original image and its associated depth map are then processed by a three-dimensional imaging method/device. This can be, for example, a view reconstruction method producing a pair of stereo views displayed on an auto-stereoscopic LCD screen.

The depth model is possibly parameterized to fit with the segmented objects. For example, for each line of the image, the end points of abscissa xl and xr of the previously generated foreground are used to partition the line between three segments:
a left segment (from x=0 to xl) is background and is assigned to depth=0.
a middle segment is foreground and could be assigned with a depth following the equation below generating a half-ellipse in [x, z] plane:

$$d = d 1 + dz \times \sqrt{1 - {[ \frac{2 \times x - xl - xr}{xr - xl} ]}^{2}}$$

where dl represents the depth assigned to the boundary and dz represents the difference between the maximum depth reached at the middle point of the segment and dl.
a right segment (from x=xr to xmax) is background and is assigned to depth=0.

Therefore, the depth modeller 308 scans the image pixel per pixel. For each pixel of the image, the depth model of the object (background or foreground) is applied to generate its depth value. At the end of this process, a depth map is obtained.

Especially for video images where the processing is done in real-time and at the video frame rate, once the first image of a video or image sequence 301 has been processed, the subsequent images are processed by the tracking module 304. The tracking module 304 may be applied to the first image of a video or image sequence 301 after the object or head/face has been detected. Once we have identified the object for three-dimensional rendering in image n, the next desired outcome is to obtain the head/face of image n+1. In other words, the next two-dimensional source of information will deliver the object or head/face of another non-first image n+1. Subsequently, a conventional motion estimation process is performed between the image n and the image n+1 in the area of the image having been identified as the head/face of image n+1. The result is a global head/face motion which is derived from the motion estimation, which can be result, for instance, by a combination of translation, zoom and rotation.

By applying this motion on the head/face n, the face n+1 is obtained. A refinement of the tracking of the head/face n+1 by pattern matching may be performed, such as the location of eyes, mouth, and face boundaries. One of the advantages provided by the tracking module 304 for a human head/face is the better time consistency compared to independent face detection on each image as independent detection gives head position unavoidably corrupted with errors, which are uncorrelated from image to image. Thus, the tracking module 304 provides the new position of the moving object continuously, and it is again possible to use the same technique as for the first image to segment the image and render the foreground in three-dimension.

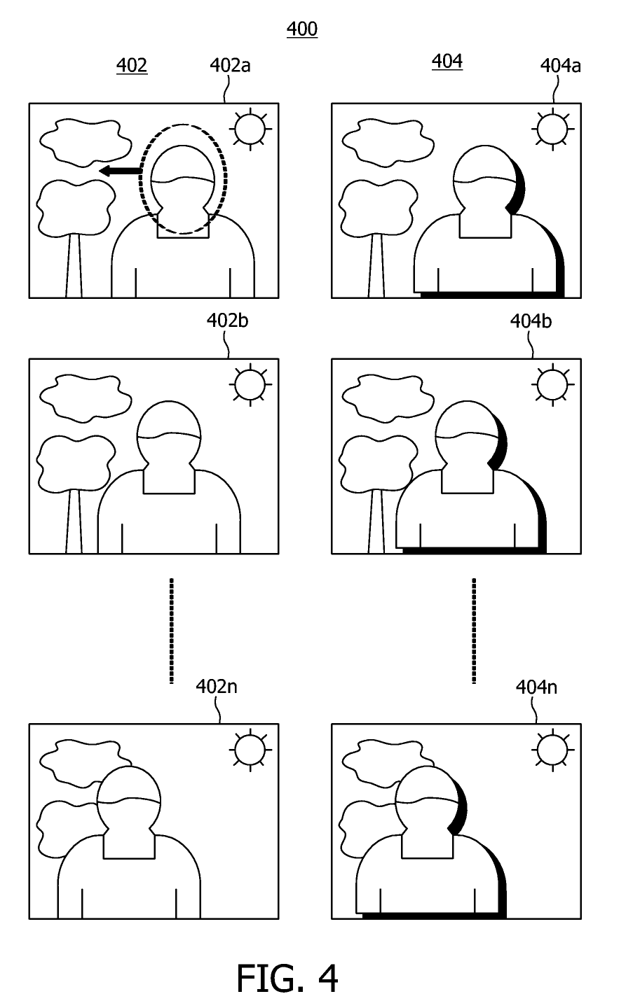

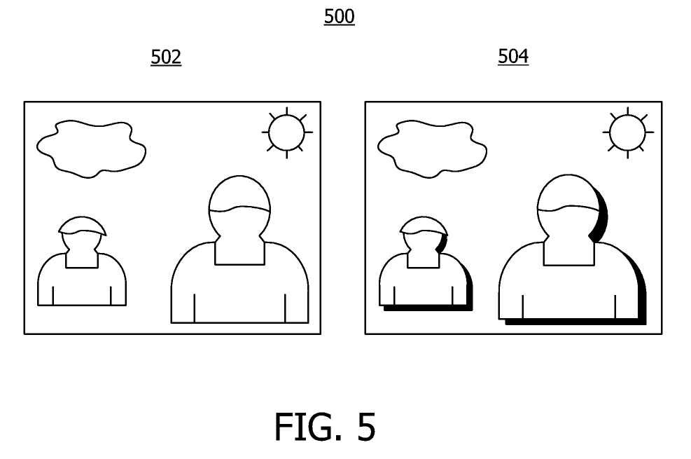

Referring now to FIG. 4, a representative illustration 400 comparing a rendering 402 of two-dimensional sequence of images and a rendering 404 of three-dimensional sequence of images is shown. The two-dimensional rendering 402 includes frames 402a-402n, whereas the three-dimensional rendering 404 includes frames 404a-404n. The two-dimensional rendering 402 is illustrated for comparative purposes only.

For example, in the illustration 400, the moving object is one person. In this illustration, on the first image of a video or image sequence 404a (the first image of a video or image sequence 301 of FIG. 3), the detection module 302 only detects the head/face of the person. Then, the segmentation module 306 defines the foreground as being equivalent to the combination of the head+the body/torso of the person.

As described above with reference to FIG. 2, the position of the body can be extrapolated after the detection of the position of the head using three techniques, namely, by applying a standard template of a human body below the head; by first scaling or adjusting the standard template of the human body according to the size of the head; or by detecting the area below the head, having the same motion as the head. The segmentation module 306 refine the segmentation of the foreground and background by also taking into account the high contrast between the edge of the person's body and the background of the image.

Many additional embodiments are possible, namely embodiments supporting more than one moving object.

Referring to FIG. 5, an illustration 500 shows an image depicting more than one moving object. Here, in both two-dimensional rendering 502 and three-dimensional rendering 504, two persons are depicted on each rendering, one of which is smaller than the other. That is, persons 502a and 504a are smaller in size on the image than persons 502b and 504b.

In this case, the detection module 302 and the tracking module 304 of the device system 300, permit the positioning and locating of two different positions and the segmentation module 306 identifies two different foregrounds coupled to one background. Thus, the three-dimensional rendering method 300 permits depth modelling for objects, mainly for human face/body, which are parameterized with the size of the head in such a way that, when used with multiple persons, larger persons appear closer than smaller ones, improving the realism of the picture.

Moreover, the invention may be incorporated and implemented in several fields of applications such as telecommunication devices like mobile telephones, PDAs, video conferencing systems, video on 3G mobiles, security cameras, but also can be applied on systems providing two-dimensional still images or sequences of still images.

It can be added here that there are numerous ways of implementing functions by means of items of hardware or software, or both. In this respect, the drawings are very diagrammatic and represent only some possible embodiments of the invention. Thus, although a drawing shows different functions as different blocks, this by no means excludes that a single item of hardware or software carries out several functions. Nor does it exclude that an assembly of items of hardware or software or both carry out a function.

The remarks made herein before demonstrate that the detailed description with reference to the drawings, illustrates rather than limits the invention. There are numerous alternatives, which fall within the scope of the appended claims. Any reference sign in a claim should not be construed as limiting the claim. The word “comprising” does not exclude the presence of other elements or steps than those listed in a claim. The word “a” or “an” preceding an element or step does not exclude the presence of a plurality of such elements or steps.

1. A method for rendering a two-dimensional source in three-dimension, the two-dimensional source including in a video or a sequence of images at least one moving object, said moving object comprising any type of object in motion, wherein the method comprises:
detecting a moving object in a first image of the video or sequence of images;
rendering the detected moving object in three-dimension;—tracking the moving object in subsequent images of the video or sequence of images; and
rendering the tracked moving object in three-dimension.

2. The method according to claim 1, wherein the moving object comprises a head and a body of a person.

3. The method according to claim 2, wherein the moving object comprises a foreground defined by the head and the body and a background defined by remaining non-head and non-body areas.

4. The method according to claim 3, further comprising segmenting the foreground.

5. The method according to claim 4, wherein segmenting the foreground comprises applying a standard template on the position of the head after detecting its position.

6. The method according to claim 5, further comprising adjusting the standard template according to measurable dimensions of the head during the detecting and tracking steps, prior to performing the segmenting step.

7. The method according to claim 4, wherein segmenting the foreground comprises estimating the position of the body relative to an area below the head having similar motion characteristics as the head and delimited by a contrasted separator relative to the background as the body.

8. The method of claim 1, further comprising tracking a plurality of moving objects, wherein each of the plurality of moving objects has a depth characteristic relative to its size.

9. The method according to claim 8, wherein the depth characteristic for each of the plurality of moving objects renders larger moving objects appear closer in three-dimension than smaller moving objects.

10. A device configured to render a two-dimensional source in three-dimension, the two-dimensional source including in a video or a sequence of images at least one moving object, said moving object comprising any type of object in motion, wherein the device comprises:
a detecting module adapted to detect a moving object in a first image of the video or sequence of images;
a tracking module adapted to track the moving object in subsequent images of the video or sequence of images; and—a depth modeller adapted to render the detected moving object and the tracked moving object in three-dimension.

11. The device according to claim 11, wherein the moving object comprises a head and a body of a person.

12. The device according to claim 11, wherein the moving object comprises a foreground defined by the head and the body and a background defined by neighboring images.

13. The device according to claim 11, further comprising a segmentation module adapted to extract the head and the body using a standard template, wherein the head and the body are defined as the foreground and remainder of the image as the background.

14. The device according to claim 11, wherein the segmentation module adjusts dimensions of the standard template based on dimensions of the head detected by the detection module.

15. The device according to claim 11, wherein the device comprises a mobile phone.

16. A computer-readable medium associated with the mobile phone of claim 16 having a sequence of instructions stored thereon which, when executed by a microprocessor of the device, causes the processor to: detect a moving object in a first image of the video or sequence of images; render the detected moving object in three-dimension; track the moving object in subsequent images of the video or sequence of images; and render the tracked moving object in three-dimension.
